(19) United States
(12) Patent Application Publication
(10) Pub. No.: US 2010/0133242 A1
(43) Pub. Date: Jun. 3, 2010

(54) LASER PIGMENTS FOR CERAMICS

(75) Inventors: Joerg Lind, Ludwigshafen (DE); Ruediger Wissemborski, Gau-Algesheim (DE); Melanie Murmann, Braunshorn (DE); Christian Kohlpaintner, Ingelheim (DE)

Correspondence Address: MICHAEL L. DUNN, SIMPSON & SIMPSON, PLLC, 5555 MAIN STREET, WILLIAMSVILLE, NY, 14221, US

(73) Assignee: Chemische Fabrik Budenheim KG, Budenheim (DE)

(21) Appl. No.: 12/451,239

(22) PCT Filed: Apr. 11, 2008
(86) PCT No.: PCT/EP2008/054448

§ 371 Date: Feb. 5, 2010

(30) Foreign Application Priority Data
May 7, 2007 (DE) 10 2007 021 820.8

(51) Int. Cl. B23K 26/00; C04B 33/04; C03C 8/00; C04B 35/00

(52) U.S. Cl. 219/121.61; 501/141; 501/14; 501/1; 501/142

(57) ABSTRACT

A coating containing metal phosphate-based compounds and mixtures, mixed compounds, mixed salts or adducts which contain such compounds as pigments for the production of single-coloured or multi-coloured markings, inscriptions and/or decorations by means of laser light in and/or on ceramic, stoneware, pottery, earthenware, porcelain, ceramic glazes, engobe, glass or glass paste (enamel). The method of marking by applying a laser to the coatings is also provided

### CROSS REFERENCE TO RELATED APPLICATIONS

This is a nationalization of International Application PCT/EP2008/054448 originally filed Apr. 11, 2008 in the German language. The content of the original PCT Application is incorporated herein by reference.

### BACKGROUND OF THE INVENTION

The present invention concerns a method and use of chemical compounds for the production of markings, inscriptions and/or decorations in and/or on ceramic, stoneware, pottery, earthenware, porcelain, ceramic glazes, engobe, glass or glass paste (enamel) by means of laser light. The marking, inscription or decoration of glazed surfaces on ceramic, stoneware, pottery, earthenware, porcelain and so forth is generally effected by applying further layers by means of screen printing or by the previous application of underglazes (underglaze painting) or overglazes.

Such layers have to be applied, stoved and fixed in a plurality of process steps.

In the case of enamelled surfaces marking, inscription or decoration is also mostly effected by applying further layers in a screen printing process or by applying a plurality of enamel layers one upon the other. Those layers also have to be stoved and fixed in a plurality of process steps. The aforementioned methods can admittedly be carried out on a large scale but they require a multiplicity of working steps, they are time-, material- and cost-intensive and in addition frequently also require the use of further chemicals.

EP 0 233 146 discloses a method of laser inscription on ceramic materials, glazes, glass ceramic and glasses, in which colour changes can be produced by admixing radiation-sensitive additives into the glass-like structures and by subsequent irradiation by means of laser light. Including pigments containing zirconium vanadium yellow, praseodymium yellow, zinc-iron-chromium spinels, zirconium iron pink, titanium dioxide, titanates, cadmium sulphides, cadmium sulphoselenides or other compounds are referred to as radiation-sensitive additives. A disadvantage of those radiation-sensitive additives is their in part considerable toxicity. A further disadvantage with that method is that it is only ever possible to produce one colour with the additives in the substrate material.

EP 0 531 584 discloses a method of inscribing or decorating a glass substrate, in which there is applied to the transparent glass an auxiliary layer containing at least two kinds of ions of transition elements, and the auxiliary layer is irradiated by means of laser light of a wavelength in the range of 0.3 μM to 1.6 μm. The laser radiation is absorbed in the auxiliary layer, whereby a heated plasma is produced in the auxiliary layer and thereby acts indirectly on the substrate. After the processing operation the auxiliary layer is removed by washing off or mechanical abrasion. What remains is an inscription or decoration on the transparent glass substrate.

A similar method is disclosed in EP 0 391 848. In that case a transparent titanium dioxide layer which is 10 to 1000 nm thick is applied to ceramic materials, glazes, glass ceramic or glasses and it is then irradiated with a pulsed laser. The oxide layer is coloured as a result. A disadvantage of that method is that the titanium dioxide layer to be irradiated is not firmly fixed on the surface and therefore the non-irradiated portion has to be removed again. In addition only a grey-black coloration can be produced with that method.

EP 1 023 184 discloses a method in which an inscription material is applied to a surface of glass or metal, that inscription material then being irradiated by means of laser light, in which case the inscription material is connected to the substrate surface. The inscription material contains an energy-absorbing enhancer which is preferably carbon black. A disadvantage of this method is that the layer to be irradiated is not fixed on the surface and therefore the non-irradiated portion has to be removed again. In addition the method can only provide single-colour inscriptions.

DE 100 53 771 discloses a method of manufacturing coloured patterns on glass, ceramic or metal, in which a coating of dye, energy absorber and flow agent is applied to the substrate and the coating is irradiated with laser light. That produces a fixed colour application. It is not possible to produce multi-colour inscriptions.

DE 198 27 070 describes a method of printing enamelled surfaces by means of ink liquid which is then fired. That method is very complicated and expensive for the coloured marking, decoration or inscription of enamel.

DE 35 39 047 describes a method of decorating or marking enamelled surfaces by means of laser beam using opacifiers which experience a change in colour due to the radiation. Oxides of titanium, tin, cerium and antimony are named as opacifiers. This method can also be used to produce only single-coloured inscriptions.

### BRIEF SUMMARY OF THE INVENTION

The object of the invention is to produce markings such as multi-coloured markings, inscriptions and/or decorations having good durability and stability and resistance in and/or on ceramic, stoneware, pottery, earthenware, porcelain, ceramic glazes, engobe, glass or glass paste (enamels).

In accordance with the invention, a novel coating suitable for laser marking is provided and a method for marking is provided by applying laser light to the novel coating of the invention.

More particularly, the invention is a coating that is a ceramic glaze, an engobe or an enamel, containing a laser markable pigment that yields different colors depending upon pulse frequency, power and application time of a laser applied to the coating. The pigment preferably includes at least one metal phosphate composition.

The invention also includes a method for forming an inscription in a coating comprising a ceramic glaze, an engobe or an enamel comprising incorporating a laser markable pigment into the coating that yields different colors depending upon pulse frequency, power and application time of a laser applied to the coating and directing a laser at a pulse frequency, power and time selected to obtain a desired color or combination of colors in the coating.

### DETAILED DESCRIPTION OF THE INVENTION

Pigments in the sense of this description are compounds or mixtures of compounds which change their colour under the influence of a laser light source at the irradiated location. The pigments used according to the invention are metal phosphate-based compounds and mixtures, mixed compounds, mixed salts or adducts which contain such compounds.

The pigments which are preferred in accordance with the invention for the production of single-coloured or multi-coloured markings, inscriptions and/or decorations include pure metal phosphates, mixtures of various metal phosphates, mixtures of metal phosphates with other metal compounds, mixed compounds containing metal phosphates, mixed salts or adducts. Particularly preferably the metals contained in the pigments are selected from the metals of the 2nd, 3rd and 4th main groups of the periodic system and/or from the metals of the 1st to 8th secondary groups of the periodic system. Phosphate-based compounds or mixtures with phosphate-based compounds which contain the metals Cu, Zn, Sn, Fe, Mn, Ti, Co, Ni and/or Zr are quite particularly preferred and suitable for the production of single-coloured or multi-coloured markings, inscriptions and/or decorations.

Quite particularly preferably the metal phosphate-based compounds are selected from copper hydroxy phosphates [Cu₃(PO₄)₂*Cu(OH)₂=libenthenite; Cu₃(PO₄)₂*2Cu(OH)₂], tricopper phosphate [Cu₃(PO₄)₂], copper pyrophosphate [Cu₂P₂O₇], copper oxide phosphate [Cu₃(PO)₂*xCuO], tin phosphate [Sn₃(PO₄)₂], manganese(III)-phosphate, iron(II)-phosphate, zinc phosphate [Zn₃(PO₄)₂] as well as hydrate forms and mixtures thereof.

The surprising novelty in the use of the pigments according to the invention is that in that way various colours such as for example red, yellow, blue, green etc can be simultaneously produced by irradiation by means of laser light in a matrix (ceramic, stoneware, pottery, earthenware, porcelain, ceramic glazes, engobe, glass or glass paste), in which respect black and white are considered as colours in accordance with this invention. Admittedly, in accordance with previously known methods and with known pigments, depending on the respective method involved and in particular the choice of the pigments, it was possible to produce various colours, but not within the same matrix with the same pigment or the same pigment composition. The invention therefore opens up a completely novel field of laser inscription with far-reaching possible uses in terms of multi-coloured design of ceramic, stoneware, pottery, earthenware, porcelain, ceramic glazes, engobe, glass and glass paste, which hitherto was possible only by multi-layer glazes and/or glazes applied in a plurality of working steps, or by screen printing processes.

If in connection with the present application reference is made to multi-coloured markings, inscriptions and/or decorations, it will be appreciated that that does not exclude being able to apply just single-coloured markings, inscriptions and/or decorations in accordance with the invention depending on the respective use and need, in which respect in this case also the invention has the advantage over known methods that different colours can be produced with the same pigment. Known methods of laser inscription for such materials generally only allow the production of a single colour for a given pigment.

The production of different colours using a pigment according to the invention is effected using laser light of different pulse frequencies and/or different power in respect of the applied laser beam. In a preferred embodiment of the invention the pulse frequency of the laser for producing different colours is varied in the range of 100 Hz to 30 kHz. Particularly preferably the pulse frequency is varied in the range of 300 Hz to 15 kHz. At the same time as or alternatively to the variation in the pulse frequency of the laser, different colours are produced by varying the power output of the laser beam. In a preferred embodiment of the invention the power of the laser is varied in the range from 0.5 mJ/s to 15 J/s (1 J/s=1 watt) for producing different colours. Particularly preferably the power of the laser is in the range of 1.0 m J/s to 10 J/s. It will be appreciated that the invention is not limited to the above-mentioned ranges of pulse frequency and power of the laser. Rather it is within the capability of the man skilled in the art, when using a given pigment according to the invention, to match the pulse frequency and the power of a laser by means of simple tests in such a way that, depending on the respective substrate and matrix material, the desired colours, colour intensities and levels of luminance which are possible using the respective pigment are produced.

The use of an Nd:YAG laser with a wavelength of 1064 nm is particularly suitable for carrying out the present invention. All other kinds of laser light sources of adequate power output are however also suitable such as for example CO₂ lasers (10.6 mm), pulse UV lasers, excimer lasers (F₂ excimer lasers (157 nm), ArF excimer lasers (193 nm), XeCl excimer lasers (308 nm), XeF excimer lasers (351 nm)) or fibre lasers of differing wavelengths (for example 1060 nm, 1080 nm, 1500 nm).

The pigments according to the invention are appropriately provided in the form of fine-grain powder and incorporated into the matrix material. In a preferred embodiment of the invention the pigments have a mean grain size of 0.15 to 100 μm and are introduced into ceramic glazes, engobe or glass paste in an amount of 1 to 35% by weight. An amount of 3 to 25% by weight is particularly preferred, an amount of 5 to 20% by weight is more preferred and an amount of 7 to 15% by weight is quite particularly preferred.

In an alternative preferred embodiment the pigments according to the invention are provided in the form of powder of a mean grain size of up to 150 nm, preferably 10 to 100 nm, particularly preferably 15 to 50 nm, and incorporated into the matrix material. Pigments of those grain sizes are referred to in the context of the present application as ‘nanofine’ pigments. It has surprisingly been found that, when using nanofine pigments, depending on the respective pigment involved, considerably smaller amounts may be required to achieve comparable colour effects as with corresponding coarser-grain pigments. Therefore nanofine pigments of the kind according to the invention are desirably used in ceramic glazes, engobe or glass paste in an amount of 0.1 to 15% by weight, preferably in an amount of 0.3 to 10% by weight, more preferably in an amount of 0.5 to 8% by weight and particularly preferably in an amount of 1 to 5% by weight.

Ceramic glazes are thin, glass-like coatings which are fused off at temperatures between 800 and 1450° C. These involve silicate-bearing glasses which are applied to ceramic substrates by different methods (for example casting, spraying or screen printing). Chemically glazes (like other glasses also) consist of a mixture of mineral powders. These are on the one hand the network formers like silicic acid (for example in the form of quartz powder) and network converters such as alkali metal and alkaline earth oxides (for example sodium and calcium oxide in the form of feldspar or chalk). Ceramic glazes, besides vitrifiers and ceramic frits, also contain other additives such as for example zinc oxide, titanium dioxide, aluminium oxide, clays, feldspars, kaolins, chalks, strontium oxides, barium oxides, lithium oxides, colour oxides or pigments which determine the properties of the respective glaze. Ceramic glazes are applied to ceramic substrates such as earthenware, stoneware, pottery or porcelain in one or more steps. The aim is to make porous ceramic substrates sealed by means of the glazes, to protect the respective surface from chemical and physical attacks and to decorate it by the use of pigments. For example the glaze on crockery improves surface roughness (better cleaning) and scratch hardness. On high voltage insulators of electroporcelain it serves on the one hand to increase the strength of the insulator by an inherent compressive stress and on the other hand it serves to reduce surface conductivity and thus the creep current by means of a suitable chemical composition.

An engobe (also referred to as a slip or casting material) is a low-viscosity dip coat which serves to colour ceramic products. After stoving the engobe is usually coated with a transparent ceramic glaze which is also stoved. The term sinter engobe is used to denote a combination of colouring and glazing elements (metal oxides or colouring bodies), it is engobe and glaze in one and has a slightly shiny surface.

Enamel involves silicate-bearing glasses which are applied to metallic substrates by different methods (casting or spraying). Enamel glasses, besides the vitrifiers, contain so-called enamel frits and other additives such as for example zinc oxide, titanium dioxide, aluminium oxide, clays, feldspars, kaolins, chalks, strontium oxides, barium oxides, lithium oxides and so forth. Enamel glasses are applied to metallic substrates or glass and are stoved at temperatures of between 800 and 1200° C., with the aim of protecting the respective surface from chemical and physical attacks and decorating it by the use of pigments.

The method according to the invention makes it possible advantageously to produce single-coloured or multi-coloured markings, inscriptions or decorations in the surfaces of ceramic, stoneware, pottery, earthenware, porcelain, ceramic glazes, engobe, glass or glass paste (enamel), in a very simple and inexpensive fashion. The use of the pigments according to the invention is quite particularly advantageous in an underglaze which is in the form of engobe and over which a transparent glaze is applied and stoved. Markings, inscriptions or decorations of different colours are produced through the transparent glaze with the laser beam without the surface being attacked in that case. Due to the glaze over the engobe the latter remains fixed and the regions coloured by laser radiation are protected from external (for example chemical or physical) attacks.

A substantial advantage of the pigments according to the invention is that they can be incorporated into ceramic materials, ceramic glazes, enamel glasses and so forth and fused or stoved together with them at the required firing temperatures, without the pigments in that case losing their capability of colour marking by means of laser light. Post-working after the marking operation by means of laser light is not required. The marking remains stable and colour-fast over a long period, in particular if the pigments are incorporated into an engobe and coated with a protecting transparent glaze.

Some methods which are suitable in accordance with the invention are described in greater detail hereinafter.

### Single-Layer Glazing Method

In the single-layer glazing method phosphate-based pigments according to the invention in powder form are meteredly added to a ceramic glaze powder and mixed. The mixture is then made into a paste with water and applied to a substrate by means of a spray gun or by hand. The substrate can comprise earthenware, stoneware, pottery, porcelain or another suitable material. After application of the glazes which are enriched with the pigment, drying is effected, followed then by firing of the glaze at between 800° C. and 1450° C. In that case the glass fuses and forms a coating which hardens upon cooling and which at ambient temperature then forms a solid glassy structure.

Subsequently thereto the ceramic substrate which is glazed and fired in a through-pass and which contains the pigment in the glaze is irradiated for example with an Nd-YAG laser of a wavelength of 1064 nm and possibly with a variation in the pulse frequency and/or the power to produce a marking, an inscription or a decoration.

### Double-Layer Glazing Method

In the double-layer glazing method phosphate-based pigments according to the invention in powder form are meteredly added to a ceramic engobe powder and mixed. The mixture is then made into a paste with water and applied to a substrate by means of a spray gun or by hand. The substrate can comprise earthenware, stoneware, pottery, porcelain or another suitable material. After application of the engobe, drying is effected, followed then by firing of the engobe at between 600° C. and 1200° C. In that case the engobe sinters and after cooling a layer which is firmly fixed on the ceramic substrate and which contains the phosphate-based pigment is formed. Subsequently thereto a transparent ceramic glaze is applied over the engobe in the form of an aqueous paste, dried and fired at temperatures between 800° C. and 1450° C. In that case the glass fuses and forms a coating which hardens upon cooling and then forms a solid glassy structure at ambient temperature.

Subsequently the ceramic substrate which is glazed and fired in two through-passes and which contains the pigment in the engobe is irradiated for example with an Nd-YAG laser of a wavelength of 1064 nm and possibly with a variation in the pulse frequency and/or the power to produce a marking, an inscription or a decoration.

### Single-Layer Enamelling Method

In the single-layer enamelling method phosphate-based pigments according to the invention in powder form are meteredly added to an enamel powder or granular material and mixed. The mixture is then made into a paste with water and applied to a substrate using a spray or dip process. The substrate is generally a metal, for example steel sheet, cast iron, aluminium, but it can also be glass or another material suitable for enamelling. After application of the enamel which is enriched with the pigment, drying is effected, followed then by firing at between 650° C. and 1200° C. In that case the glass fuses and forms a coating which hardens upon cooling and which at ambient temperature then forms a solid glassy structure.

Subsequently thereto the ceramic substrate which is enamelled and fired in a through-pass and which contains the pigment in the enamel layer is irradiated for example with an Nd-YAG laser of a wavelength of 1064 nm and possibly with a variation in the pulse frequency and/or the power to produce a marking, an inscription or a decoration.

### Colours

The colours which can be produced by the method according to the invention are specified herein by the L*a*b* colour system. The L*a*b* colour system was developed in 1976 by the CIE Commission from the CIE-XYZ model. It is standardised, uniformly spaced, independent of device and based on human perception. It is based on the XYZ colour system, but luminance is plotted separately from the colour shades on its own axis. In comparison with the CIE standard colour table the green shades appear greatly restricted in the a*- and b*-system while the purple-blue-cyan region is greatly stretched.

The colour space of the L*a*b* system is arranged as follows:

The a- and the b-axes form a plane. The scale of both axes includes a region from −128 to +127. All green and red shades are on the a*-axis. In that respect negative a-values represent green colours and positive a-values represent red colours. On the b-axis, all blue shades are in the negative region and all yellow shades are in the positive region. That arrangement is to be attributed to the opponent colour theory of Ewald Hering. It states that the human colour vision is based on four primary colours with the two opponent set pairs blue-yellow and red-green. Colour locations which are on the same circle line around the L*-axis have the same chroma C* and colour locations which are on the same radius line have the same colour shade or hue h. If all colour shades are arranged in a row with each other that gives a colour spectrum.

The luminance axis (L: luminance) extends vertically relative to the a- and b-plane. An L-value of 0 produces black and an L-value of 100 produces white. The colours are perceptible for a human being only in a range which is different in colour-specific fashion. Thus visible yellow can attain b*-values of over 100 whereas blue can only attain b*-values around −50. There is therefore a very irregular shape for the colour space which can only be reproduced in greatly simplified form by the usual representation as a cylinder or ball.

### EXAMPLES

### Example 1

### Production of a Single-Layer Ceramic Glaze

A ceramic pottery glaze in powder form of the composition 64.2% by weight of SiO₂, 9.8% by weight of Al₂O₃, 6.3% by weight of CaO, 3.8% by weight of BaO, 2.9% by weight of K₂O, 8.0% by weight of ZnO, 2.1% by weight of MgO and 2.0% by weight of Na₂O were mixed with the desired amount of pigment and the mixture was then put into suspension in water. The suspension produced in that way was applied with a spray gun to a ceramic acid-resistant stoneware tile and dried for 1 to 4 hours at 110° C. Ceramic firing of the glazed stoneware tile was then effected at 1220° C., in which respect heating was firstly effected within an hour from ambient temperature to 550° C., thereafter within an hour from 550° C. to 750° C. and finally within an hour from 750° C. to 1220° C. The temperature of 1220° C. was maintained for 2 hours. The tile was then allowed to cool to ambient temperature. After cooling the finished ceramic tile was marked by means of an Nd-YAG laser of a wavelength of 1064 nm, with various markings being applied with different pulse frequencies and powers of the laser.

### Example 2

### Production of a Double-Layer Ceramic Glaze with Engobe and Transparent Ceramic Glaze Applied Thereover

A ceramic engobe in powder form based on a plastic clay, a kaolin and a ceramic glaze fit of the composition 64.2% by weight of SiO₂, 9.8% by weight of Al₂O₃, 6.3% by weight of CaO, 3.8% by weight of BaO, 2.9% by weight of K₂O, 8.0% by weight of ZnO, 2.1% by weight of MgO and 2.0% by weight of Na₂O were mixed with the desired amount of pigment and the mixture was then put into suspension in water. The suspension produced in that way was applied with a spray gun to a ceramic acid-resistant stoneware tile and dried for 24 hours at 110° C. Thereafter firing of the engobe was effected at 900° C., in which respect heating was firstly effected within 2 hours from ambient temperature to 350° C., and then at full power to 900° C. The temperature Of 900° C. was maintained for 30 minutes.

After cooling of the tile a pottery glaze suspended in water was applied by means of a spray gun. Ceramic filing was then effected at 1220° C., heating being effected firstly within an hour from ambient temperature to 550° C., thereafter within a further hour from 550° C. to 750° C. and then within a further hour from 750° C. to 1220° C. The temperature of 1220° C. was maintained for two hours. The tile was then left to cool to ambient temperature.

That method produced two layers fired on the ceramic substrate, of which the lower one contained the laser-activatable pigment and the upper one served as a transparent cover layer.

After cooling the finished ceramic substrate was marked by means of an Nd-YAG laser of a wavelength of 1064 nm, with various markings being applied with different pulse frequencies and powers of the laser.

The advantage of this method is that the laser light penetrates through the transparent glaze and in the engobe produces a single-coloured or multi-coloured marking which is protected by the transparent glaze disposed thereover and remains fixed.

### Example 3

### Production of an Enamel Layer

An enamel granular material based on an unground glass frit of the composition 51.7% by weight of SiO₂, 4.8% by weight of Al₂O₃, 8.2% by weight of K₂O 1.6% by weight of ZnO, 11.0% by weight of Na₂O, 3.4% by weight of P₂O₂ and 19.1% by weight of TiO₂, a binding clay, potassium hydroxide, sodium aluminate and sodium nitride were mixed with a desired amount of the pigment according to the invention. The mixture was then ground in a glaze ball mill with the addition of water. The finely divided suspension produced in that way was applied with a spray gun to a cleaned metal sheet and then dried for 5 minutes at 110° C. Thereafter firing of the enamel layer was effected in a pass at 820° C. for 4 minutes in a furnace already heated to that temperature.

After cooling the enamelled sheet was marked by means of an Nd-YAG laser of a wavelength of 1064 nm, wherein different pulse frequencies and powers of the laser were used for different markings.

### Example 4

### Laser Marking

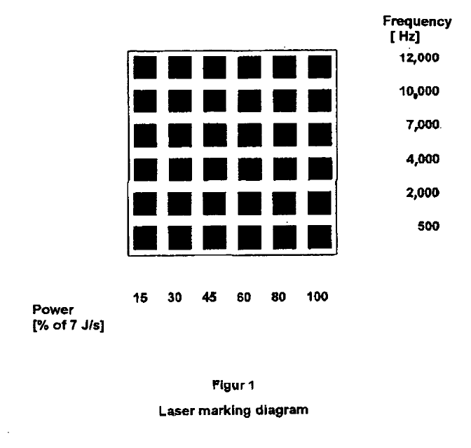

Marking of the substrates was effected in a DPL Genesis Marker (ACI Lasercomponents GmbH) and using the Magic Mark Lasermarkingsoftware (ACI Lasercomponents GmbH). 6×6 square markings were applied to each substrate, wherein each six markings were implemented with 15%, 30%, 45%, 60%, 80% and 100% respectively of the laser power of 7 Vs (watts). Within the six markings produced at the same laser power, each marking was implemented with a different pulse frequency of the laser of 500 Hz, 2000 Hz, 4000 Hz, 7000 Hz, 10,000 Hz and 12,000 Hz. The marking layout is shown in FIG. 1. The speed of the laser beam on the substrate was kept constant for the same substrate in each case, but could be varied for different substrates and was in the range of 10 mm/s to 100 mm/s.

### Example 5

### Characterising the Samples

The morphology of the marked surfaces was investigated by means of an optical microscope (Praktica 5 MP Luxmedia 5203; Leica) at a magnification of 10.

The depth of penetration of the markings into the material was determined with an electron microscope (Personal SEM: RJ Lee Instruments). For that purpose the marked ceramic tiles were cut up by means of a water-cooled diamond saw, dried and then investigated in terms of their cross-section.

The chemical composition of the marked regions was examined prior to and after the laser treatment by means of X-ray photoelectron spectroscopy (XPS; LH 10 ESCA; Leybold-Heraeus). AIK₆ radiation was used for that purpose.

For determining the colours produced a GretagMacbeth Color-eye Spectrophotometer 2180/2180 UV with D 65-illumination was used, and the above-described L*a*b* colour system applied.

To investigate colour fastness the samples were dipped into 1% HCl solution and 1% NaOH solution respectively for 30 minutes and any colour changes noted.

### Example A

### Single-Layer Ceramic Glaze

Ceramic tiles with a single-layer ceramic glaze with pigment according to the invention were produced in accordance with the above-described method and marked in accordance with the system also described hereinbefore. A glaze without pigment was used as a control. The pigments used are set forth in Table 1 hereinafter.

TABLE 1
Single-layer ceramic glaze

| Ex. | | |
|---|---|---|
| number | Pigment | % wt. |
| A1 | copper hydroxy phosphate (66.5% CuO, 30% P₂O₅, | 10% |
| | balance H₂O) | |
| A2 | copper pyrophosphate + tin phosphate (55% CuO, 30% | 5% |
| | P₂O₅, 15% SnO) | |
| A3 | copper oxide phosphate (69% CuO, 31% P₂O₅) | 10% |

### Colour Analysis

Colour analyses were carried out in the above-described manner on some selected markings of intensive colour. The results are set out in Table 2 hereinafter. ‘Standard’ in each case identifies the colour analysis on a region of the sample which has not been irradiated with laser light.

TABLE 2
Colour analysis of the single-layer ceramic glazes

| Ex. | | | | | |
|---|---|---|---|---|---|
| number | Pulse frequency/% of 7 J/s | Colour | L* | a* | b* |
| A1 | — | standard | 46.8 | −7.2 | 6.2 |
| A1 | 12000 Hz 30% | green | 42.1 | −2.4 | 1.7 |
| A1 | 1200 Hz 100% | red | 36.6 | 9.7 | 6.9 |
| A1 | 7000 Hz 100% | yellow | 51.0 | −0.5 | 14.3 |
| A2 | — | standard | 61.5 | −12.4 | 0.3 |
| A2 | 12000 Hz 80% | green | 53.4 | −8.6 | 4.0 |
| A2 | 10000 Hz 100% | silver-white | 64.9 | −5.6 | 6.1 |
| A2 | 12000 Hz 100% | red | 56.7 | −0.3 | 4.3 |
| A2 | 4000 Hz 100% | brown | 39.7 | 2.6 | 8.4 |
| A3 | — | standard | 46.0 | −6.4 | 6.2 |
| A3 | 500 Hz 45% | green | 46.0 | −3.1 | 2.5 |
| A3 | 7000 Hz 100% | red | 39.3 | 11.5 | 8.9 |

### Example B

### Enamel

Metal sheets were produced with an enamel layer with pigment according to the invention in accordance with the above-described method and marked with the system also as described hereinbefore. A glaze without pigment was used as a control. The pigments used are set forth in Table 3 hereinafter.

TABLE 3
Enamel

| Ex. | | |
|---|---|---|
| number | Pigment | % wt. |
| B1 | copper hydroxy phosphate (66.5% CuO, 30% P₂O₅, | 10% |
| | balance H₂O) | |
| B2 | nanofine copper hydroxy phosphate (compos. like | 1% |
| | B1-A4; 20-40 nm) | |
| B3 | copper oxide phosphate (69% CuO, 31% P₂O₅) | 10% |

### Colour Analysis

Colour analyses were carried out in the above-described manner on some selected markings of intensive colour. The results are set out in Table 4 hereinafter. ‘Standard’ in each case identifies the colour analysis on a region of the sample which has not been irradiated with laser light.

TABLE 4
Colour analysis enamel

| Ex. | | | | | |
|---|---|---|---|---|---|
| number | Pulse frequency/% of 7 J/s | Colour | L* | a* | b* |
| B1 | — | standard | 76.3 | −13.3 | 2.2 |
| B1 | 4000 Hz 100% | gold-brown | 45.1 | 4.1 | 24.6 |
| B1 | 1200 Hz 80% | light brown | 71.9 | −9.3 | 9.0 |
| B2 | — | standard | 90.5 | −4.6 | 2.3 |
| B2 | 7000 Hz 100% | red | 70.1 | 2.1 | 11.3 |
| B2 | 10000 Hz 100% | yellow | 87.9 | −5.6 | 4.6 |
| B2 | 4000 Hz 100% | black | 37.6 | 1.9 | 10.1 |
| B3 | — | standard | 75.0 | −14.8 | 5.1 |
| B3 | 12000 Hz 100% | dark brown | 34.1 | 9.4 | 15.9 |
| B3 | 12000 Hz 60% | gold-brown | 41.3 | 6.2 | 22.7 |
| B3 | 7000 Hz 60% | yellow | 65.9 | −9.8 | 19.7 |

It was possible to produce different colours with the pigments according to the invention within the same substrate and with the same pigment at different pulse frequencies and power levels of the laser. The principal colours were green, red, yellow, blue and brown, wherein luminance and colour gradations of those principal colours were obtained according to the respective pulse frequency and laser power.

What is claimed is:

1-10. (canceled)

11. A material comprising a ceramic, stoneware, pottery, earthenware or porcelain or a coating comprising a ceramic glaze, an engobe or an enamel, said material containing a laser markable pigment that yields different colors depending upon pulse frequency, power and application time of a laser applied to the material.

12. The material of claim 11 wherein the pigment comprises at least one metal phosphate composition.

13. The material of claim 12 where the pigment comprises at least one metal phosphate wherein the metal is from the 2^{nd}, 3^{rd}, and 4^{th} main groups of the periodic table or from the 1^{st} through 8^{th} secondary groups of the periodic table.

14. The material of claim 12 wherein pigment comprises at least one phosphate of Cu, Zn, Sn, Fe, Mn, Ti, Co, Ni or Zr.

15. The material of claim 12 where the metal phosphate composition is selected from the group consisting of a copper hydroxyl phosphate, a tri-copper phosphate, a copper pyrophosphate, a copper oxide phosphate, a tin phosphate a manganese (III) phosphate, an iron phosphate, a zinc phosphate, hydrates thereof and mixtures thereof.

16. The material of claim 13 in the form of a coating applied to a substrate, which substrate is selected from the group consisting of ceramic, earthenware, stoneware, pottery, porcelain, glass, and metal.

17. The material of claim 13 laser treated to provide multi-colored markings.

18. The material of claim 11 wherein the pigment has a mean grain size of 0.15 to 100 μm and is in an amount of from 1 to 35 percent by weight.

19. The material of claim 18 wherein the pigment is present in an amount of from 3 to 25 percent by weight.

20. The material of claim 18 wherein the pigment is present in an amount of from 7 to 15 percent by weight.

21. The material of claim 11 wherein the pigment has a mean grain size of less than 150 nm and is in an amount of from 0.1 to 15 percent by weight.

22. The material of claim 21 wherein the pigment has a mean grain size of from 15 to 50 nm and is present in an amount of from 0.3 to 10 percent by weight.

23. The material of claim 21 wherein the pigment is present in an amount of from 7 to 15 percent by weight.

24. A method for forming an inscription in a material comprising a ceramic, stoneware, pottery, earthenware or porcelain or a coating comprising a ceramic glaze, an engobe or an enamel, comprising incorporating a laser markable pigment into the material that yields different colors depending upon pulse frequency, power and application time of a laser applied to the material and directing a laser at a pulse frequency, power and time selected to obtain a desired color or combination of colors in the material.

25. The method of claim 24 wherein the pigment comprises at least one metal phosphate composition.

26. The method of claim 24 where the pigment comprises at least one metal phosphate wherein the metal is from the 2^{nd}, 3^{rd}, and 4^{th} main groups of the periodic table or from the 1^{st} through 8^{th} secondary groups of the periodic table.

27. The method of claim 24 wherein pigment comprises at least one phosphate of Cu, Zn, Sn, Fe, Mn, Ti, Co, Ni or Zr.

28. The method of claim 25 where the metal phosphate composition is selected from the group consisting of a copper hydroxyl phosphate, a tri-copper phosphate, a copper pyrophosphate, a copper oxide phosphate, a tin phosphate a manganese (III) phosphate, an iron phosphate, a zinc phosphate, hydrates thereof and mixtures thereof.

29. The method of claim 24 where the material is in the form of a coating on a substrate selected from the group consisting of ceramic, earthenware, stoneware, pottery, porcelain, glass, and metal.

30. The method of claim 24 wherein the pigment has a mean grain size of 0.015 to 100 μm and is in an amount of from 1 to 35 percent by weight.
